(19) United States
(12) Patent Application Publication
(10) Pub. No.: US 2005/0038923 A1
(43) Pub. Date: Feb. 17, 2005

(54) Electronic apparatus, processing method and program

(75) Inventor: Takahisa Kamataki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/787,153

(22) Filed: Feb. 27, 2004

(30) Foreign Application Priority Data
Aug. 14, 2003 (JP) 2003-293321

(51) Int. Cl. G06F 3/00; G06F 13/12; G06F 13/38

(52) U.S. Cl. 710/5; 709/201; 710/65

(57) ABSTRACT

In a server, a server processing unit stores files input from a file I/O unit such as a card slot into the file storage unit in conformity with predefined processing rules corresponding to file types. An additional processing instruction unit forces the server processing unit to execute a predefined additional processing corresponding to the file type when the instruction of the additional processing is determined. The file I/O unit inputs an image file or a music file and stores it in accordance with the file type. The additional processing instruction unit executes storage and printout by a printer at the same time in the case of the image file and executes storage and playback by a client simultaneously in the case of the music file.

### BACKGROUND OF THE INVENTION

1. Field of the Invention

The present invention relates generally to a server or other electronic apparatus, processing method and program for use in a home network, etc., and more particularly to a server or other electronic apparatus, processing method and program, for storing and administering images of digital cameras and music data.

2. Description of the Related Arts

Recently, with diffusion of information equipments centering on personal computers, the situation in which a plurality of personal computers are used arises even in households, and it is desirable to construct a home network for sharing a broadband line or video/image data and exchanging messages between family members, by linking these information equipments. In order to correspond to such utilization of information equipments in households, the server for linking information equipments in a household as a family network station is in practical use and is becoming to widespread, and the utilization is expected to rapidly expand in the future. These servers for constructing home networks enable to exchange information with each other by linking information equipments in households, as well as are provided with functions as file servers for storing data which can be utilized from all the personal computers connected with the network, therefore it is possible to store pictures from digital cameras and music data captured from audio systems to be enjoyed by all the family members

Incidentally, if a user stores data into a server, for example storing a picture taken by a digital camera, after setting recording medium of the digital camera into a PC card slot, for example, of the server using an adaptor and opening an application for the home network installed in a personal computer which acts as a client, procedures by the user, such as for example:
(1) moving a file;
(2) selecting the file in the destination; and
(3) executing a process to the file are needed, therefore a problem of complicated operations has been posed.

Also, when the server stores data, the user have to perform management operation of a storage place, such as newly creating a folder, determining a folder name and setting the storage place, therefore the operations are complicated in this point. Particularly, if personal computers used as the server and the client are installed in separate rooms, file storage operation must be performed in another room after setting the medium into the server, and therefore very inconvenient situation arises. Further, in the possible case that, for example, storing the data and printing picture with a printer is desirable to perform simultaneously, after a user completes the storage of the data, the user have to further perform operations needed for printing with the personal computer on the client side as another process to the stored data, therefore problem arises from much effort and time needed to print.

### SUMMARY OF THE INVENTION

According to the invention, there is provided a server, processing method and program for simplifying file storage into a server, as well as enabling any processing of the files to be effected in common way regardless of file types. To achieve the above object, according to the present invention there is provided an electronic apparatus, such as a server, connected to at least a client and a printer, the electronic apparatus comprising a file I/O unit, such as a card slot interface, for inputting and outputting files; a file storage unit for storing files; a server processing unit (process unit) for storing files input from the file I/O unit 56 into the file storage unit in conformity with predefined processing rules corresponding to file types; and an additional processing instruction unit for forcing the server processing unit to execute predefined additional processing corresponding to the file type when an instruction of additional processing is determined. At this point, the file I/O unit inputs files from medium connected directly to a connection port such as a card slot of an apparatus or via an adaptor. Also, the file I/O unit 56 inputs image files or music files. The server processing unit stores the input files into domains corresponding to file types in the file storage unit. The server processing unit generates a file name for each input files and stores the input files with the file names into the domains corresponding to file types in the file storage unit. The server processing unit divides inside of the domains corresponding to file types in the file storage unit into dated domains based on date information of the input files and stores the input files. The server processing unit generates the file name for each input files, divides inside of the domain corresponding to file types in the file storage unit into dated domains based on date information of the input files, sorts and stores the input files with the file names by date. The server processing unit generates the file names (yyyymmddhhnn) which are the date information (yyyymmddhh) of the input files added with serial numbers (nn), divides inside of the domain corresponding to file types in the file storage unit into dated domains, sorts and stores the input files with the file names by date. The additional processing instruction unit recognizes and handles an instruction of an additional processing from manipulation of a switch disposed on the apparatus. Also, the additional processing instruction unit recognizes and handles an instruction of additional processing from the client. If the input file is an image file, the additional processing instruction unit forces the server processing unit to print out by the printer. If the input file is a music file, the additional processing instruction unit forces the server processing unit to play back music. If the input file is a music file, the additional processing instruction unit forces the server processing unit to generate a play list and send it with the music file to a music server.

The present invention provides a processing method of an electronic apparatus such as a server connected to at least a client and a printer. The server processing method comprises:
a file input step of inputting a file;
a file storage step of storing the input file into the file storage unit in conformity with a predefined processing rule corresponding to a file type; and
an additional processing step of, when the instruction of the additional processing is determined, effecting on the input file predefined additional processing corresponding to the file type. The file storage step may include generating a file name for each of the input files, dividing inside of domains of the file storage unit corresponding to file types into dated domains based on date information of the input files, and sorting and storing the input files by date with the file names imparted thereto. The additional processing step may include, when the input file is an image file, forcing a printer connected to the server to print out, and may include, when the input file is a music file, forcing a client connected to the server to play back music.

The present invention provides a program executed by a computer making up an electronic apparatus such as a server connected to at least a client and a printer. The program is operable to cause the computer to execute:
a file input step of inputting a file;
a file storage step of storing the input file into the file storage unit in conformity with a predefined processing rule corresponding to a file type; and
an additional processing step of, when the instruction of the additional processing is determined, effecting on the input file predefined additional processing corresponding to the file type. The file storage step may include generating a file name for each of the input files, dividing inside of domains of the file storage unit corresponding to file types into dated domains based on date information of the input files, and sorting and storing the input files by date with the file names imparted thereto.

The additional processing step may include, when the input file is an image file, forcing a printer connected to the server to print out, and may include, when the input file is a music file, forcing a client connected to the server to play back music. The other details of the server processing method and the program will become the same as those of the server of the present invention.

According to the invention, when file data is input to an electronic apparatus such as a server, the file type is determined, and storage of the file into the server can be simplified according to processing rules corresponding to the file type without the need for intervention of a user. Thus, when a user stores files, the user does not need to newly create folders, reserve storage places and perform operations for determining storage places for each file and moving files. Also, the files are stored inside of the storage domain corresponding to the file type which is divided based on date information of the files by date, therefore, utilization and administration, such as file reference by the user, will be performed very conveniently. Further, if the user wants to store a file and print it with a printer simultaneously, for example by instructing an additional processing by manipulating a switch of the server in advance, the file storage and the print output by the printer are performed simultaneously, and it is possible to easily execute a process other than the file storage. Further, by defining the additional processings corresponding to the file types such that, for example, image files are printed out and music files are played back, it is possible to execute the additional processings corresponding to the file types with common operation which is the same switch manipulation regardless of file types.

The above and other objects, aspects, features and advantages of the present invention will become more apparent from the following detailed description when taken in conjunction with the accompanying drawings.

### BRIEF DESCRIPTION OF THE DRAWINGS

FIG. 1 is an explanatory diagram of a home network to which the invention is applied;

FIG. 2 is a front view of a server according to the invention;

FIG. 3 is a back view of a server according to the invention;

FIG. 4 is an explanatory diagram of inserting a memory card of a digital camera into a card slot of a server of the invention;

FIGS. 5A and 5B are block diagrams illustrating a functional structure of a server according to the invention;

FIG. 6 is an explanatory diagram of a hardware environment of a computer to which the server of the invention is applied;

FIG. 7 is an explanatory diagram of a list of processings corresponding to file types defined in file processings of the invention;

FIG. 8 is an explanatory diagram of a list of processings corresponding to image files which defines different rules in image files of the invention;

FIG. 9 is an explanatory diagram of a shared folder screen of a client used for file management in the server of the invention;

FIG. 10 is an explanatory diagram of an image file processing rule setting screen for setting corresponding processings for image files to the server of the invention;

FIG. 11 is an explanatory diagram of a music file processing rule setting screen for setting corresponding processings for image files to the server of the invention;

FIG. 12 is an explanatory diagram of a file management screen of a client instructing an additional processing to the server of the invention;

FIG. 13 is a flowchart illustrating a server process of the invention;

FIG. 14 is a flowchart of the image file process in FIG. 13;

FIG. 15 is a flowchart of another image file process in FIG. 13;

FIG. 16 is a flowchart illustrating flag control of an additional processing instruction in FIG. 14 and FIG. 15;

FIG. 17 is a flowchart of an image file storage process in FIG. 14 and FIG. 15;

FIG. 18 is a flowchart of another image file storage process in FIG. 14 and FIG. 15;

FIG. 19 is a flowchart of another image file storage process in FIG. 14 and FIG. 15;

FIG. 20 is a flowchart of a music file process in FIG. 13;

FIG. 21 is a flowchart of another music file process in FIG. 13;

FIG. 22 is an explanatory diagram of a list of processings corresponding to file types defined in file processings of the invention in which storage playback and streaming playback are set for music playback; and

FIG. 23 is an explanatory diagram of a music file processing rule setting screen for setting corresponding processings for music files to the server of the invention.

### DESCRIPTION OF THE PREFERRED EMBODIMENTS

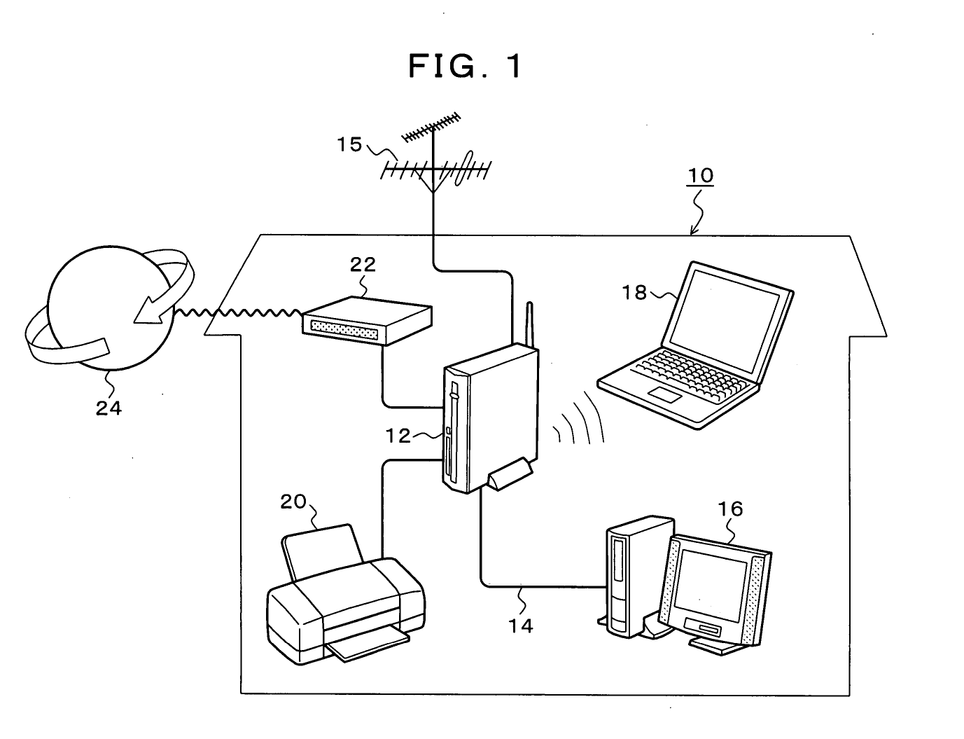

FIG. 1 is an explanatory diagram of a home network in which the server of the invention is used. In FIG. 1, in the home network 10, the server 12 of the invention is installed as a network station, and a personal computer 16 which acts as a client is connected to the server 12 via a LAN cable 14 and also connected via a wireless line to a personal computer 18 which acts as a client by using a wireless LAN disposed on the server 12. Further, the server 12 is connected with a television antenna 15, also is connected with a printer 20 and additionally, can be connected to the internet 24 via a modem 22. By constructing such home network 10, the server 12 of the invention achieves network functions enabling to share the internet connection, to share the printer 20, to share files, to share music and to view and record television programs in the personal computers 16 and 18 possessed by family members.

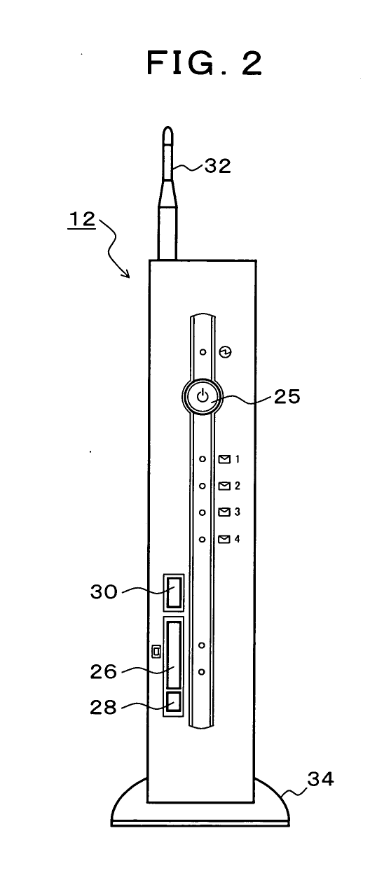

FIG. 2 is a front view of the server 12 according to the invention. The server 12 is installed on a pedestal 34, has a power button 25 in the upper part of the front face and is provided with a card slot 26 which is a medium connection port and a card eject button 28 on the lower side. Also, an additional processing instruction switch 30 is provided above the card slot 26.

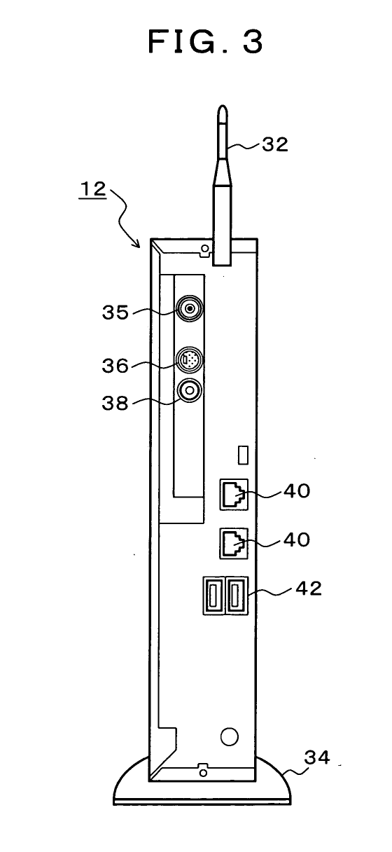

FIG. 3 is a back view of the server 12 of the invention. A LAN antenna 32 is disposed on the upper part of the wiring of the server 12 and constructs a wireless LAN with other information equipments. The back face of the server 12 is provided with an antenna input terminal 35, a video input terminal 36, line input terminal 38, and two each of WAN connectors and USB connectors, from top to bottom.

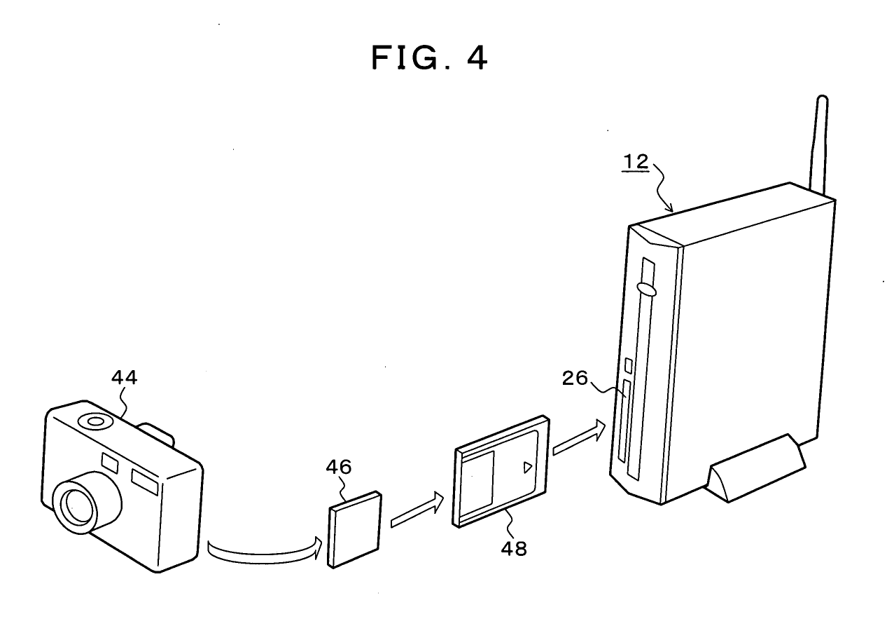

FIG. 4 is an explanatory diagram when reading an image file from a memory card of a digital camera in the server of the invention. Since image files taken by the digital camera 44 are stored in the memory card 46, by setting the memory card 46 in a card adaptor 48 and inserting it into the card slot 26 of the server 12, the image files taken by the digital camera 44 in the memory card 46 can be captured by the server 12. As the memory card 46, the SD Memory Card and the Memory Stick may be used. Also, the image data may be directly captured by using a USB cable with the digital camera 44 and connecting it to the server 12. Further, in the case that images taken by the digital camera has been printed by a printer separately, the image data may be captured into the server 12 by reading it with a scanner.

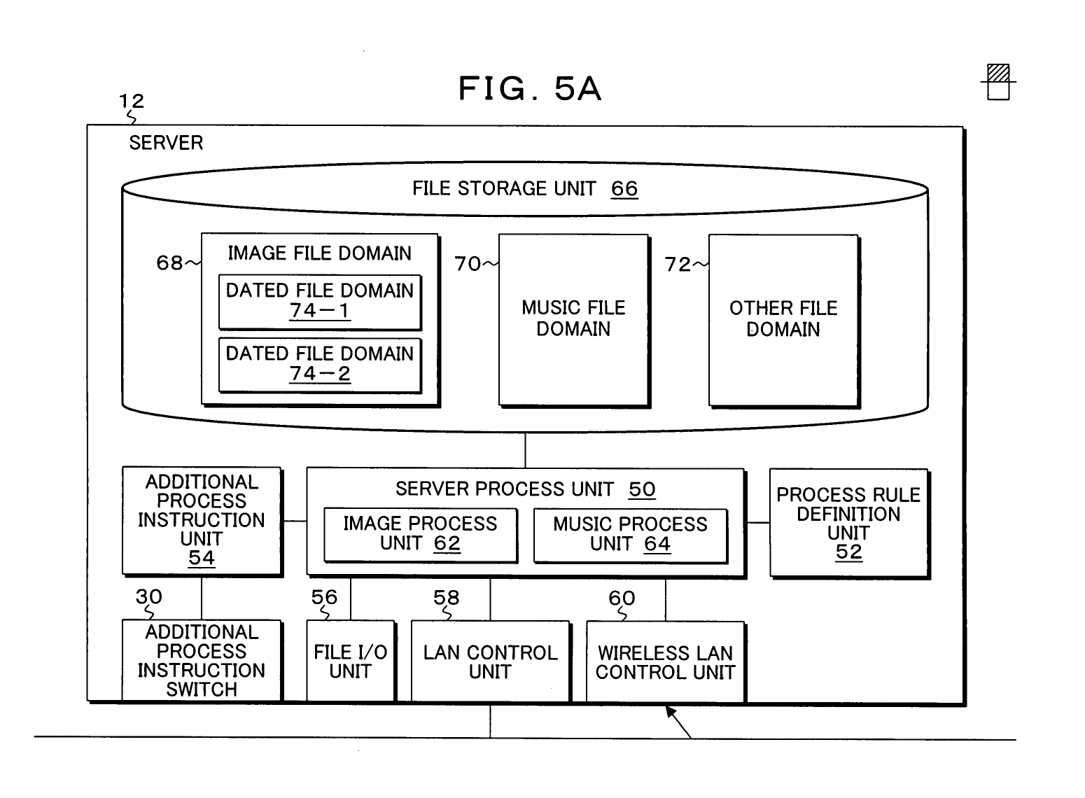

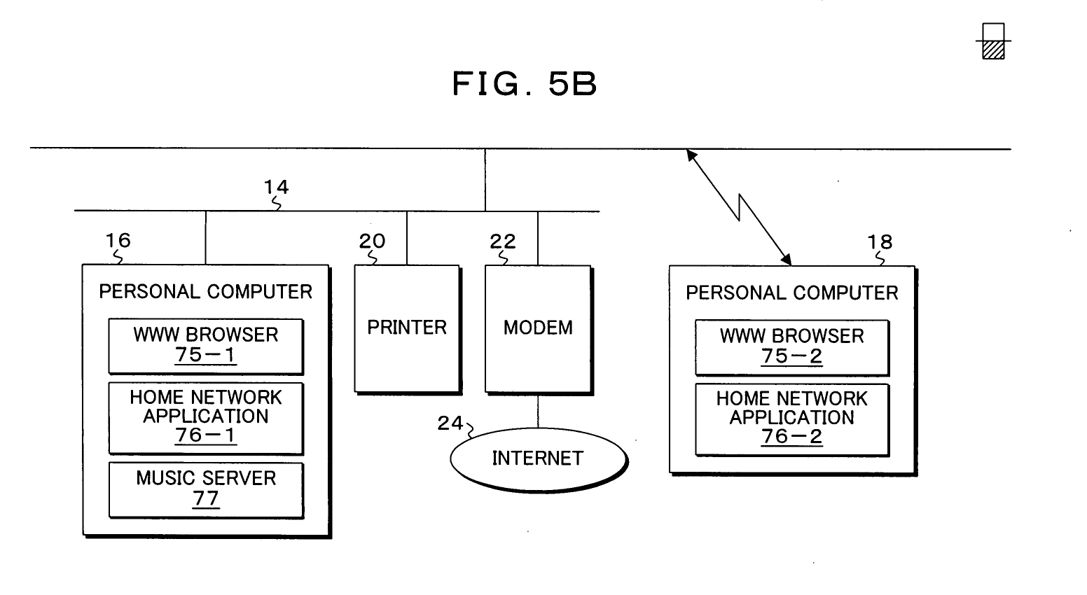

FIGS. 5A and 5B are block diagrams illustrating a functional structure of the server 12 according to the invention. In FIGS. 5A and 5B, the server 12 is connected via a LAN cable 14 with, for example, the personal computer 16, the printer 20 and the modem 22, and connected via a wireless LAN with the personal computer 18. The server 12 is provided with a server processing unit 50, a processing rule definition unit 52, an additional processing instruction unit 54, the additional processing instruction switch 30, a file I/O unit 56, a LAN control unit 58, a wireless LAN control unit 60 and a file storage unit 66. At this point, the file I/O unit 56 includes appropriate I/O interfaces such as the card slot interface for inserting and inputting the memory card with the card adaptor 48 as shown in FIG. 4 and the USB interface with a USB cable. In this embodiment, the server processing unit 50 is provided with an image processing unit 62 and a music processing unit 64, since image files taken by digital cameras and music files captured from the internet or audio apparatuses are subject to be processed. Also, the file storage unit 66 is provided with an image file domain 68, a music file domain 70 and other file domain 72, corresponding to the file type processed in the server processing unit 50. Out of these domains, the image file domain 68 is provided with dated file domains 74-1 and 74-2 for sorting and storing the image files by date. On the other hand, in the personal computers 16 and 18 which act as the clients, a WWW browser 75-1 and 75-2 and home network applications 76-1 and 76-2 corresponding to the home network of the invention are installed. Also, in this example, a music server 77 is installed as an application program on the side of the personal computer 16. The server processing unit 50 disposed on the server 12 stores files input from the file I/O unit 56 into the file storage unit 66 according to predefined rules corresponding to the file types. Also, when the additional processing instruction unit 54 identifies an instruction of additional processing from the additional processing instruction switch 30 or from the side of the personal computer which is described later, it forces the server processing unit 50 to execute predefined process corresponding to the file types. In this embodiment, since the server processing unit 50 handles image files of digital cameras and music files, if the additional processing instruction unit 54 identifies an additional instruction when storing an image file, it forces to print out with printer simultaneously. Also, if the additional processing instruction unit 54 identifies an additional instruction when storing a music file, it forces to playback by sending the music file to the personal computer 16 and 18. As the additional processing executed based on this instruction of the additional processing simultaneously with storage of the music file, it may be possible to execute process which generates a play list from the music file which is input as a storage object and sends the generated play list to the music server 77 which is installed in the personal computer 16. The processing rules for the file storage by the server processing unit 50 corresponding to the file types and the additional processings corresponding to the file types when the instruction of the additional processing is identified in the additional processing instruction unit 54 are defined in the processing rule definition unit 52.

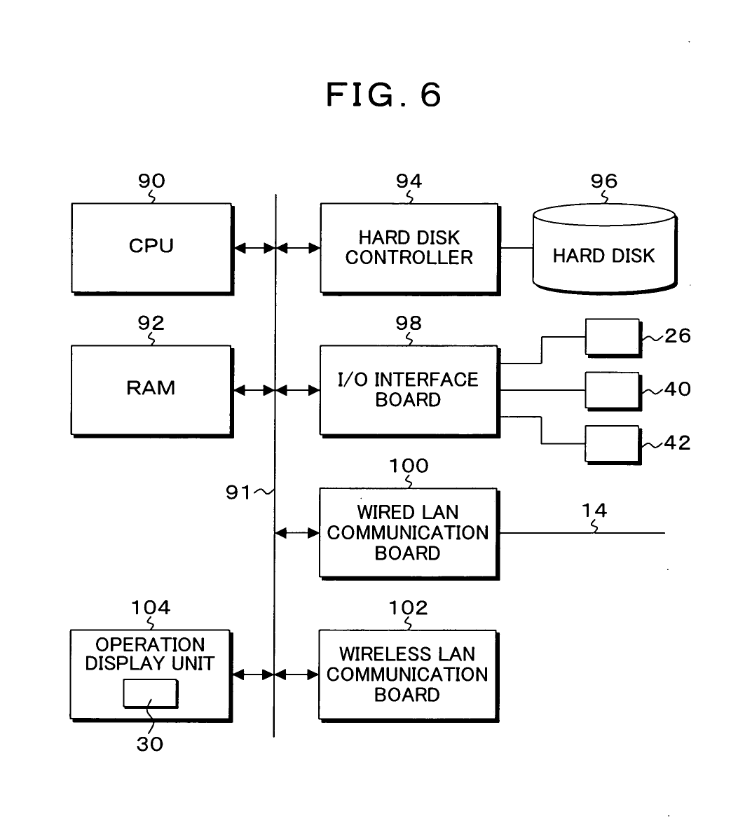

FIG. 6 is explanatory diagram of a hardware environment of a computer to which the server 12 of the invention is applied. In the computer of FIG. 6, a bus 91 of CPU 90 is connected with RAM 92, a hard disk controller 94 for controlling a hard disk drive 96, an I/O interface board 98 connected with the card slot 26, the WAN connector 40 and the USB connector 40, a wired LAN communication board 100 connected with the LAN cable 14, a wireless LAN communication board 102 and an operation display unit 104 provided with the additional processing instruction switch 30 used in the invention. In the hard disk drive 96, programs for executing the server process of the invention is loaded, and on startup of computer, necessary programs are called by the hard disk controller 94 from the hard disk drive 96, deployed on RAM 92 and executed by CPU 90. The I/O interface board 98 is provided with interface functions corresponding to each of the card slot 26, the WAN connector 40 and the USB connector 40 and, in the server process, executes input and output processings for the image files and the music files. The wired LAN communication board 100 is provided with a LAN interface function and exchanges data with the personal computer 16, the printer 20 and the modem 22 which are connected via the LAN cable 14. The wireless LAN communication board 102 is provided with a wireless LAN interface function and exchanges data with, for example, the personal computer 18 via wireless line. Further, the operation display unit 104 is comprised of various operation units and display units disposed on the server 12 of the invention shown in FIG. 2 and FIG. 3, and out of these units, the additional processing instruction switch 30 used in the server process of the invention is illustrated.

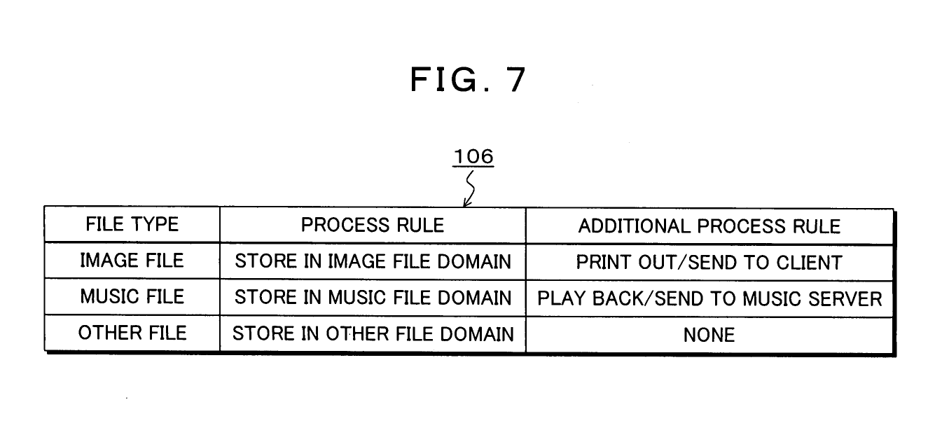

FIG. 7 is an explanatory diagram of a list of processings corresponding to file types 106 defined in the processing rule definition unit 52 disposed on the server 12 of FIGS. 5A and 5B. The list of processings corresponding to file types 106 defines the processing rules for the file storage and the additional processing rules executed by the additional processing instruction for each file type. In this example, “store in image file domain” is defined as the processing rule for the image files, and “print out/send to client” is defined as the additional processing rule. Also, for the music files, “store in music file domain” is defined as the processing rule, and “play back/send to music server” is defined as the additional processing rule. Further, for other files, the processing rule is “store in other file domain”, and the additional processing rule is “none”. For the additional processing rule of the image files and the music files, although two (2) rules are listed in this example, either rule is defined selectively.

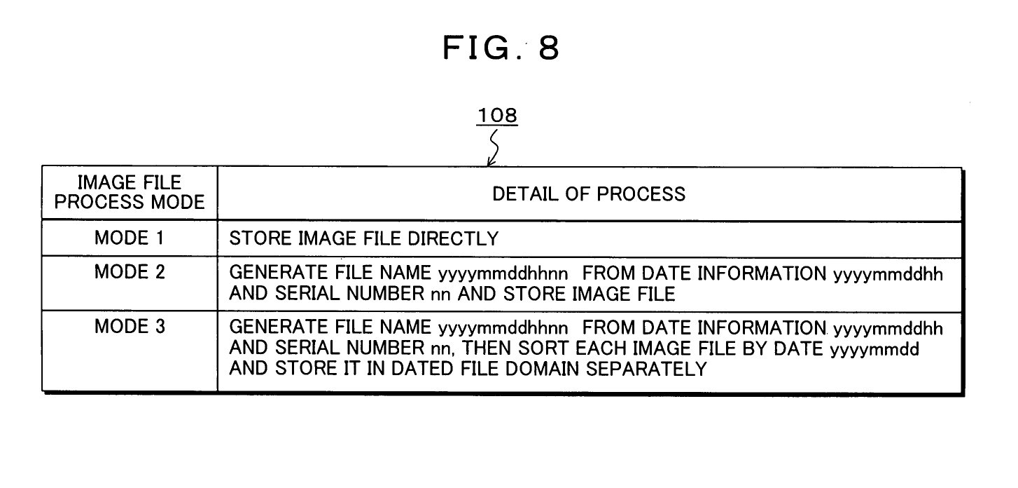

FIG. 8 is an explanatory diagram of a list of processings corresponding to image files 108, in which the processing rule to image files defined as “store in image file domain” in FIG. 7 is divided by mode. In other words, even for the processing rule for storing the image files into the image file domain, multiple process modes may be considered as details of the process for storage. Therefore, in the invention, three (3) modes, which are mode 1, mode 2 and mode 3, are defined in the list of processings corresponding to image files 108 as the image file process modes, and user can select and set contents of the process as appropriate. These modes 1 to 3 are as follows, for example.

(Mode 1)

Store the input image file directly.

(Mode 2)

Generate a file name yyyymmddhhnn from date information yyyymmddhh and a serial number nn of the input image file and store the image file added with the file name.

(Mode 3)

Generate a file name yyyymmddhhnn from date information yyyymmddhh and a serial number nn of the input image file, then sort each of the image files by date, in other words, into the files which have common yyyymmdd in the file name, and store it in the dated file domain separately.

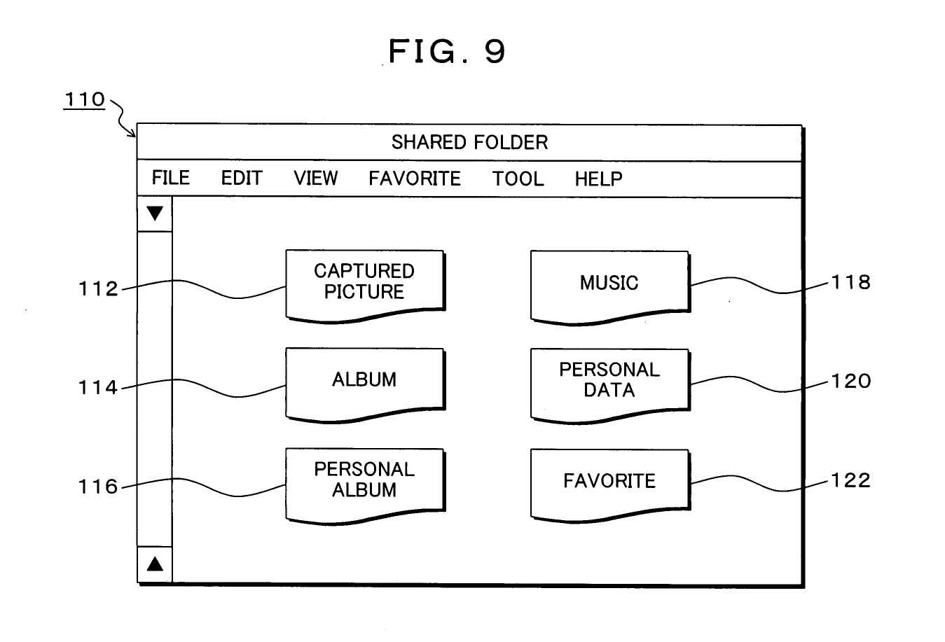

FIG. 9 is an explanatory diagram of a shared folder screen 110 of the personal computers 16 and 18 on the client side used for file management in the server 12 of the invention, and the screen is provided by executing the home network applications 76-1 and 76-2 disposed on the personal computers 16 and 18 as shown in FIGS. 5A and 5B. In the shared folder screen 110 of FIG. 9, a captured picture folder 112, an album folder 114, a personal album folder 116, a music folder 118, a personal data folder 120 and a favorite folder 122 are shown. In the captured picture folder 112, the image files of the digital cameras are stored, and the storage is performed according to the storage processing rule of the image files which has the process detail of mode 3 in FIG. 8 as a default. In other words, new folder is generated with a folder name “yyyymmddhhnn”, which is “date+two-digit serial number”, based on the date that the image file is captured, and the image file is stored in it. The image files captured in the captured picture folder 112 may be organized by changing the folder name in a file edit process and copying to the album folder 114 or the personal album folder 116, for example. The album folder 114 can be displayed by the home network applications 76-1 and 76-2 of the personal computers 16 and 18 linked on the network and can be utilized by all the family members. The personal album folder 116 can be viewed only by the owner of the folder and cannot be viewed by others. But, by checking personal folder references by an administrator, others can view it too. The music folder 118 stores the music files input from the memory cards, CD, the internet and others. For the music files stored in the music folder 118, by generating a play list and sending it to the music server 77 installed in the personal computer 16 of FIGS. 5A and 5B according to the additional processing corresponding to the folder types of the music file, when the play list is clicked during the music server is accessed from another personal computer, the clicked music file may be read out from the music folder 118 and send to the requesting personal compute to be played back as music. Of course, when the instruction of the additional processing is identified simultaneously with the storage process of the music file of the invention, it is possible to send the music file to certain personal computer and force it to perform music playback.

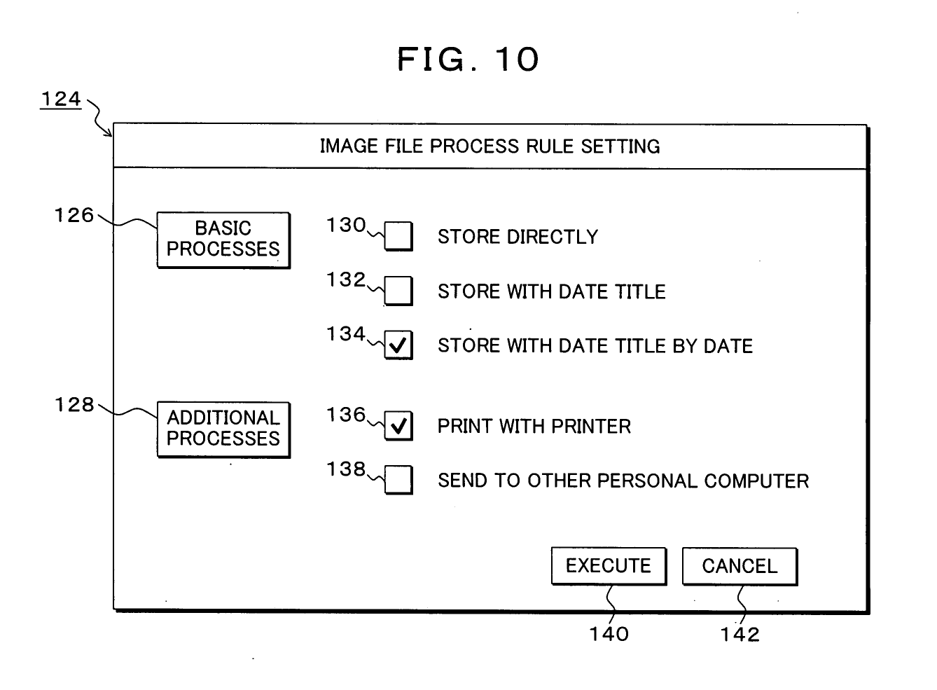

FIG. 10 is an explanatory diagram of an image file processing rule setting screen of the personal computer for setting the corresponding processings for image files to the processing rule definition unit 52 in the server 12 of the invention. In the image file processing rule setting screen 124, three (3) processings, which are “store directly” of a check box 130, “store with date title” of a check box 132 and “store with date title by date” of a check box 134, are available as basic processings 126, and the check box 134 is set as a default. Also, as additional processings 128, two (2) processings, which are “print with printer” of a check box 136 and “send to other personal computer” of a check box 138, are available, and the check box 136 is set as a default. Therefore, if the user wants to set the image file processing rules other than the default, by opening this image file processing rule setting screen 124, selecting the check box needed for the basic processings 126, also selecting the check box needed for additional processings 128 and clicking an OK button 140, the list of processings corresponding to file types 106 of FIG. 7 will be reset to this setting. Of course, three (3) check boxes 130, 132 and 134 for the basic processings 126 represent any one of the mode 1 to 3 in the list of processings corresponding to image files 108 shown in FIG. 8.

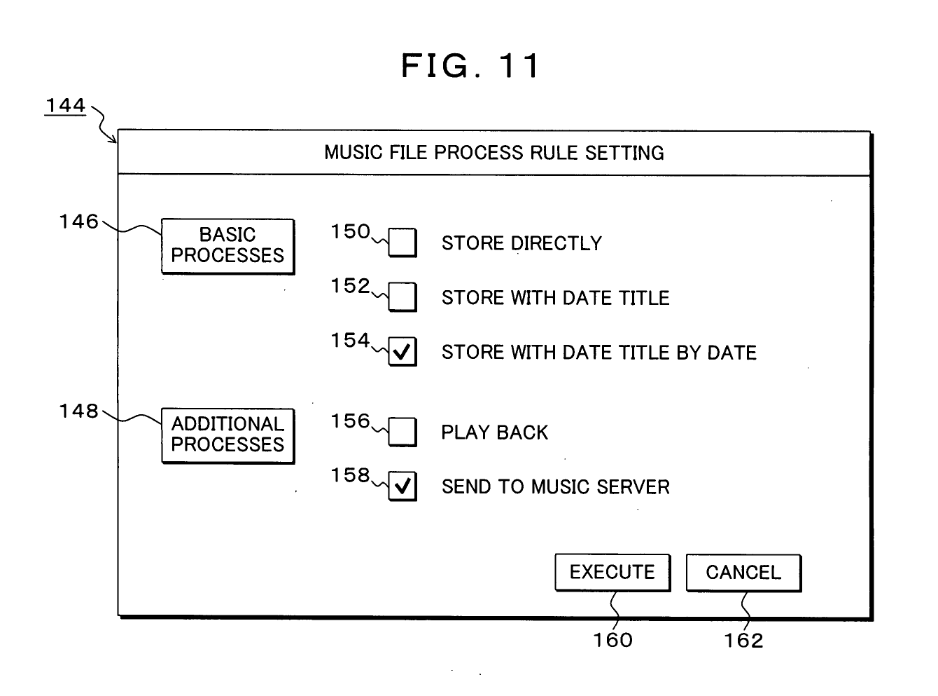

FIG. 11 is an explanatory diagram of a music file processing rule setting screen 144 stored in the server 12 of the invention. To this music file processing rule setting screen 144, three (3) processings, which are “store directly” of a check box 150, “store with date title” of a check box 152 and “store with date title by date” of a check box 154, are provided as basic processings 146, and also, as additional processings 148, two (2) processings, which are “play back” of a check box 156 and “send to music server” of a check box 158, are provided. And as a default, the check box 146 is set for the basic process 146, and the check box 158 is set for the additional processing 148. It is noted that the date title used for the check boxes 152 and 154 in the basic process 146 are a temporary title in the case of the music file, and it is possible to edit for song titles, performer names and others in an edit process after storage of the music file. Also, for the music files input from CD and the like, information for song titles, performer names and others is added, therefore it may be possible to add the title automatically based on this music information and sort the storage place by a genre. In addition, the rule setting of FIG. 10 and FIG. 11 may not be provided, and the processing rule for the basic process and the additional processing may be defined in a fixed manner.

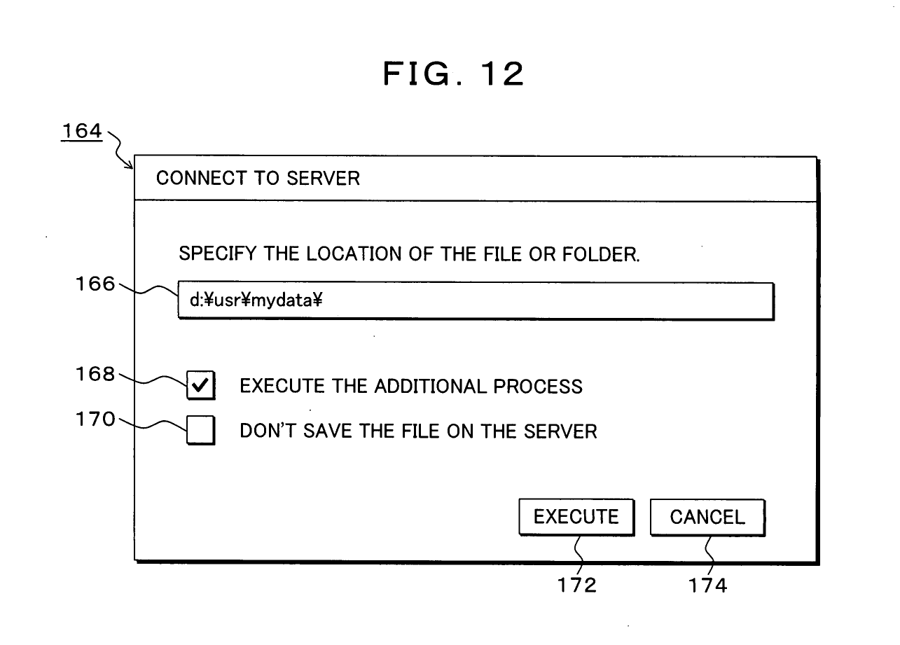

FIG. 12 is an explanatory diagram of a file management screen 164 of a personal computer instructing an additional processing to the server 12 of the invention. For the additional processing instruction unit 54 of the server 12 shown in FIGS. 5A and 5B, instruction of the additional processing may be conducted not only by the manipulation of the additional processing instruction switch 30 disposed on the server 12 itself, but also by the home network applications 76-1 and 76-2 in the personal computers 16 and 18 which act as the clients. For this instruction of the additional processing from the side of the personal computers 16 and 18, the file management screen 164 as shown in FIG. 12 is used. The file management screen 164 has a storage location 166 of the file or folder; “execute the additional processing” can be specified by a check box 168; and “don't save the file on the server” can be selected by a check box 170. In this example, by clicking the check box 168, “execute the additional processing” is set, so if an execution button 172 is clicked in this condition, the additional processing will be executed for the additional processing instruction unit 54 of the server 12, simultaneously with the storage corresponding to the file types which is concurrent with the file input. Also, in this file management screen 164, by clicking the check box 170, the additional processing may be executed without storing the file into the server.

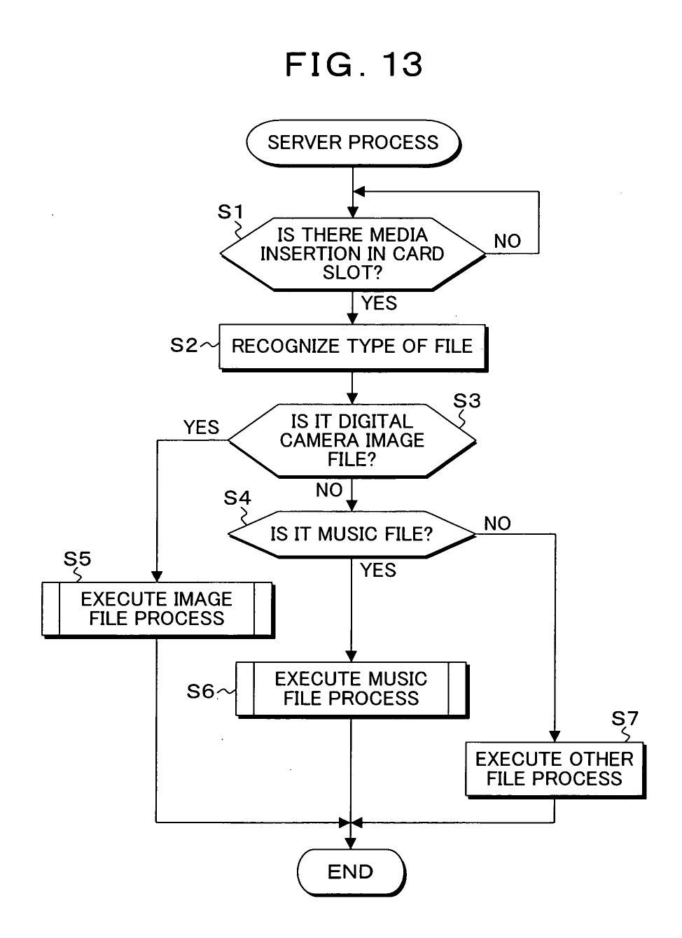

FIG. 13 is a flowchart of a server process procedure concurrent with file input in the server 12 of the invention shown in FIGS. 5A and 5B, these details correspond to the process program in the server 12. In FIG. 13, first, whether medium insertion to the card slot 26 and the like is present or not is checked in step S1. For example, when the memory card 46 storing the images taken by the digital camera 44 is set to the card adaptor as shown in FIG. 4 and inserted to the card slot 26, this insertion of the memory card is identified, and the procedure proceeds to step S2. In step S2, the type of the file from the medium inserted in the card slot is recognized. In this embodiment, the type of the file is any one of the image file, the music file and other files. Then, in step S3, whether it is the image file of the digital camera or not is determined, and if it is the image file, the procedure proceeds to step S5, and the process for the image file is executed. If it is not the image file, whether it is the music file or not is determined is step S4. If it is the music file, then the procedure proceeds to step S6, and the process for the music file is executed. In step S4, if it is not the music file, then the procedure proceeds to step S7, and the process for other files is executed.

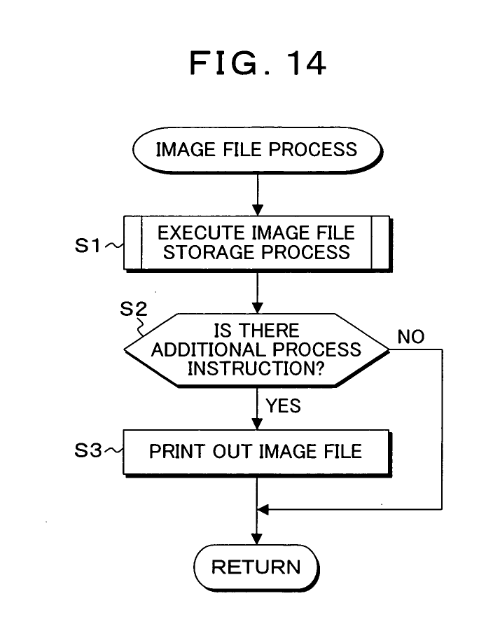

FIG. 14 is a flowchart of the image file process in step S5 of FIG. 13. In this image file process, after executing the storage process for the image file in step S1, whether the additional processing instruction is present or not is determined in step S2, and if the instruction of the additional processing is present, then the procedure proceeds to step S6, and the image file is printed out.

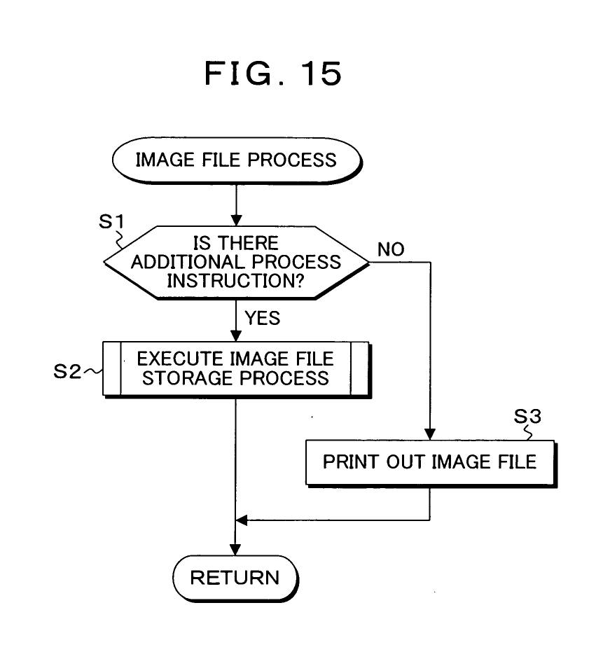

FIG. 15 is a flowchart of another process mode of the image file process in step S5 of FIG. 13. In this image file process, whether the additional processing instruction is present or not is determined in step S1, and if the instruction is not present, then the storage process of the image file is executed in Step S2. On the other hand, if the instruction of the additional processing is present in step S1, then image file is printed out by the printer in step S3. In this case, the storage of the image file will not be executed. This image file process in FIG. 15 corresponds not only to the execution of the additional processing according to the check box 168 of the file management screen 164 in FIG. 12, but also to the process in the case that the process in which the file is not stored in the server is set by the check box 170 and notified to the server 12. Also, two (2) processing methods of the image file, which are the case that the image file is stored and printed out when the instruction of the additional processing is present in FIG. 4 and the case that the image file is printed out without storing it when the instruction is present in FIG. 15, may be separated not only by the setting of the file management screen 164 of the personal computer, but also by the timing of operation of the additional processing instruction switch 30 disposed on the server 12. For example, if the order of the operations is:

(1) insert the medium to the card slot; and

(2) manipulate the additional processing instruction switch 30, then the image file process of FIG. 14 is executed.

Contrary to this, if the order of the operations is:

(1) manipulate the additional processing instruction switch 30; and

(2) insert the medium to the card slot, then the image file process of FIG. 15, in which the file is printed out by the printer without storing it, is executed.

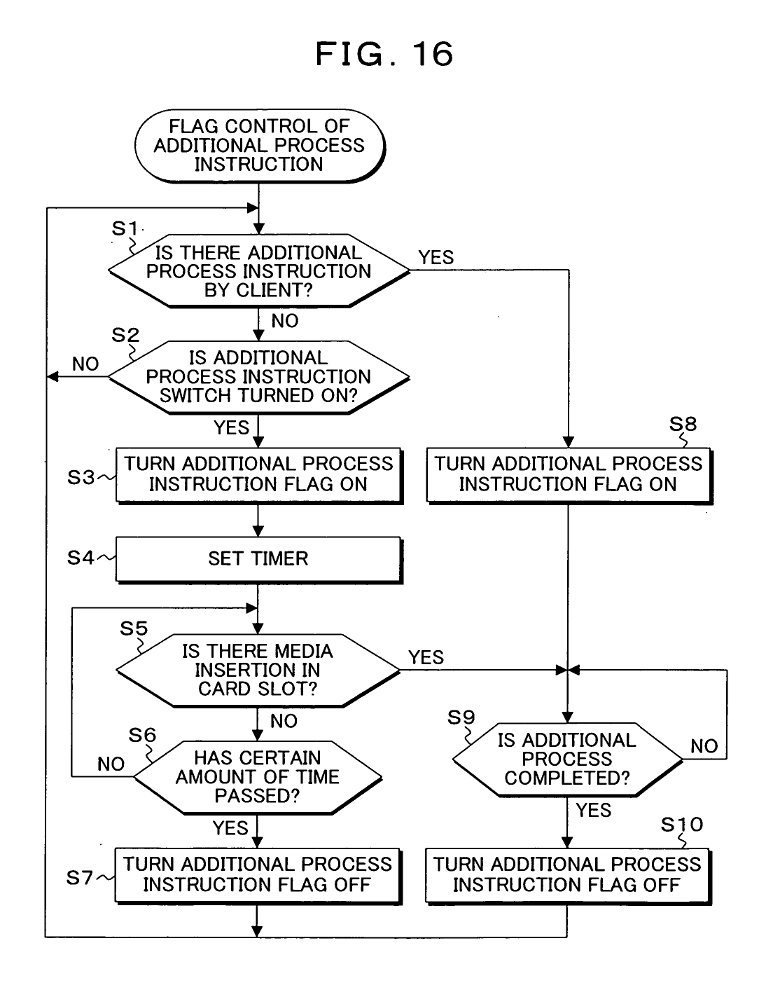

FIG. 16 is a flowchart illustrating control process of an additional processing instruction flag used in determination of the instruction of the additional processing in FIG. 14 and FIG. 15. If the additional processing instruction flag is turned on, it is determined that the instruction of the additional processing is present, and if turned off, it is determined that the instruction of the additional processing is not present. In FIG. 16, first in step S1, whether the instruction of the additional processing from the personal computer is present or not is checked, and if the instruction from the personal computer is not present, then the procedure proceeds to step S2, and whether the additional processing instruction switch 30 of the server 12 is turned on or not is checked. If it is determined that the additional processing instruction switch 30 is turned on, the additional processing instruction flag is turned on in step S3. Subsequently, a timer is set in step S4. After the timer is set, in step S5, whether the medium is inserted to the card slot 26 or not is determined. If the medium is not inserted, then the procedure proceeds to step S6, and whether certain amount of time has passed on the timer set in step S4 or not is determined. If certain amount of time has not passed, then the procedure goes back to step S5 to check the medium insertion in the card slot. If certain amount of time has passed on the timer, the procedure proceeds to step S7, and the additional processing instruction flag is turned off. In other words, in the process of these steps S2 to S7, if the additional processing instruction switch 30 of the server 12 is manipulated to turn it on, whether the medium insertion is executed or not will be monitored for certain amount of time according to the timer, and if the medium insertion will not executed, the function according to the manipulation of the additional processing instruction switch 30 to turn it on will be canceled. If it is determined that the medium is inserted to the card slot 26 before certain amount of time has passed since the additional processing instruction switch 30 was turned on, then the procedure proceeds to step S9, and completion of the additional processing is checked. If the additional processing is competed, then the procedure proceeds to step S10, and the additional processing instruction flag is turned off. On the other hand, if the instruction of the additional processing according to the file management screen 164 as shown in FIG. 12 from the personal computer is present in step S1, then the procedure proceeds to step S8; the additional processing instruction flag is turned on; completion of the additional processing is checked is step S9; and if the completion is determined, the additional processing instruction flag is turned off in step 10. In addition, for the control of the additional processing instruction flag, in order to enable termination during the additional processing, if the additional processing instruction switch 30 is manipulated again to turn it on when the additional processing instruction flag is already turned on, the additional processing may be forced to be terminated in the middle.

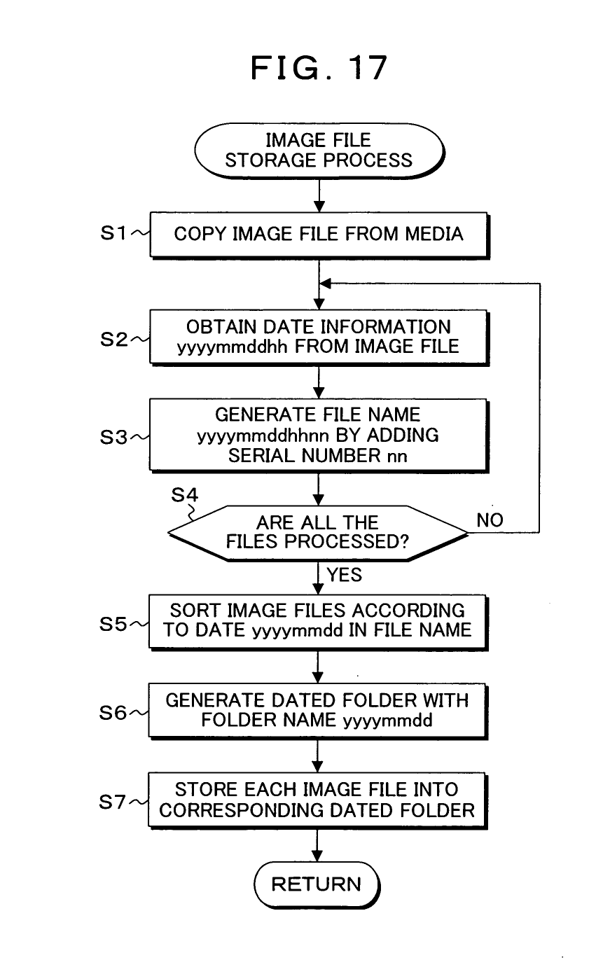

FIG. 17 is a flowchart of the image file storage process in FIG. 14 and FIG. 15, and the process taken as an example is in the case that the image file is stored with the file name and sorted by date, according to the setting of the mode 3 in the list of processings corresponding to image files 108 of FIG. 8. In FIG. 17, after copying the image file from the medium in step S1, the date of capture “yyyymmddhh” which is the date information of the image file is obtained in step S2; the procedure proceeds to step S3; and by adding the serial number “nn” to this, the file name “yyyymmddhhnn” is generated. Subsequently, whether all the files are processed or not is checked in step S4, and if not processed, then the procedure goes back to step S3 to execute the file name generation process for next file. If all the files are processed in step S4, then the procedure proceeds to step S5, and the image files are classified into the units of the image files which has common date “yyyymmdd” in the file name and separated by date according to this. Then, the dated folders which has the folder names “yyyymmdd” is generated in step S6, and each image file is stored into the corresponding dated folders in step S7. According to this storage process for the image file, for multiple image files input from the memory card of the digital camera, it is possible to classify the image files into folder units separated by date based on the date information each image file has, therefore, when opening the stored file to change the file name, or when copying to the album folder 114 or the personal album folder 116 shown in the shared folder screen 110 of FIG. 9 to create an album, the edit operation may be easier to perform because the files are organized by date.

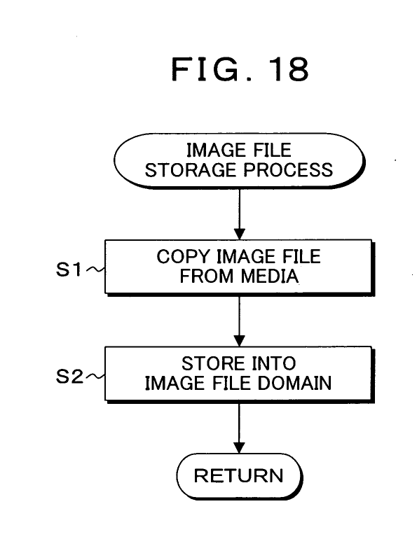

FIG. 18 is a flowchart of another image file storage process in FIG. 14 and FIG. 15. This process has the details of the process for the mode 1 in the list of processings corresponding to image files 108 of FIG. 8. In other words, in the image file storage process in FIG. 18, after copying the image file from the medium in step 1, it is stored directly into the image file domain in step S2.

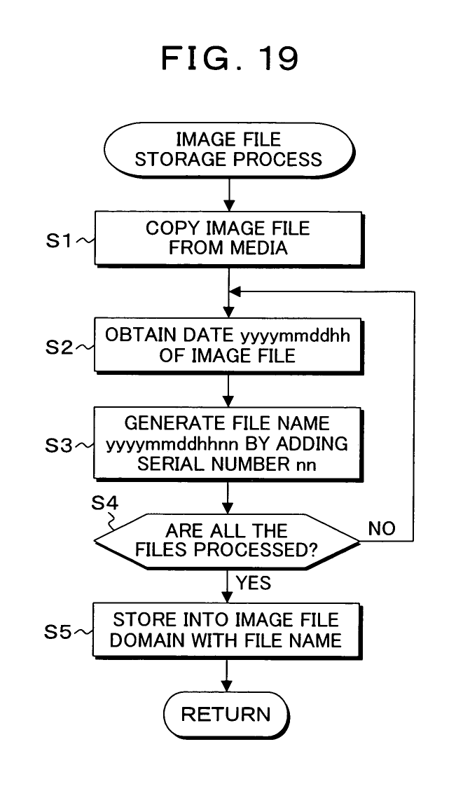

FIG. 19 is a flowchart of another image file storage process in FIG. 14 and FIG. 15 and corresponds to the details of the process for the mode 2 in the list of processings corresponding to image files 108 of FIG. 8. In the image file storage process in FIG. 19, after copying the image file from the medium in step S1, the date “yyyymmddhh” of the image file is obtained in step S2, and by adding the serial number “nn” to this in step S3, the file name “yyyymmddhhnn” is generated. If it is determined that the process of steps S2 and S3 is executed to all the files in step S4, the files are stored with the file name generated in step S5 into the image file domain in step S5.

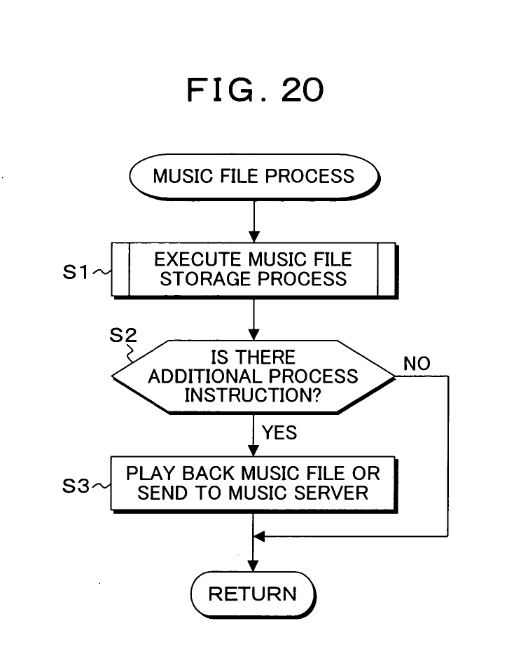

FIG. 20 is a flowchart of the music file process in FIG. 13. In this music file process, after executing the music file storage process in step S1, whether the instruction of the additional processing is present or not is checked in step S2, and if the instruction of the additional processing is present, the music file is played back or transmitted to the music server in step S3.

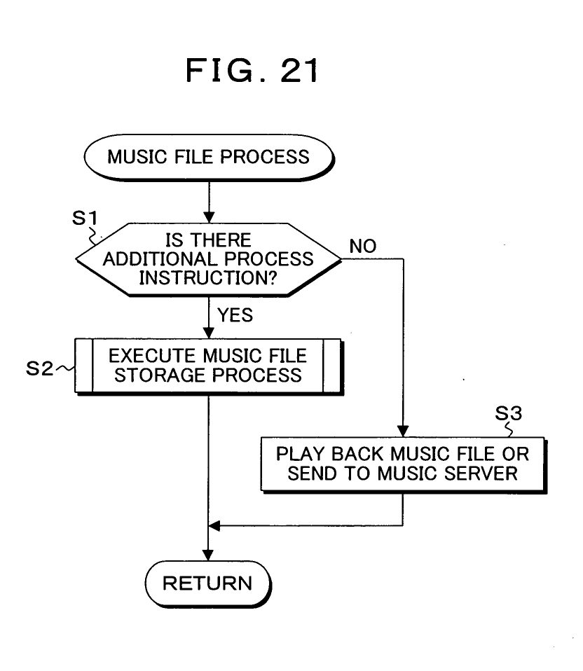

FIG. 21 is another flowchart of the music file process in FIG. 13. In this music file process, whether the instruction of the additional processing is present or not is checked in step S1, and if the instruction is not present, the storage process of the music file is executed in step S2. On the other hand, if the instruction of the additional processing is identified in step S1, the procedure proceeds to step S3 to execute the play back of the music file or the transmission to the music server, and the storage of the music file is not performed. The music file process of FIG. 20 corresponds to the image file process of FIG. 14, and the music file process of FIG. 21 corresponds to the image file process of FIG. 15.

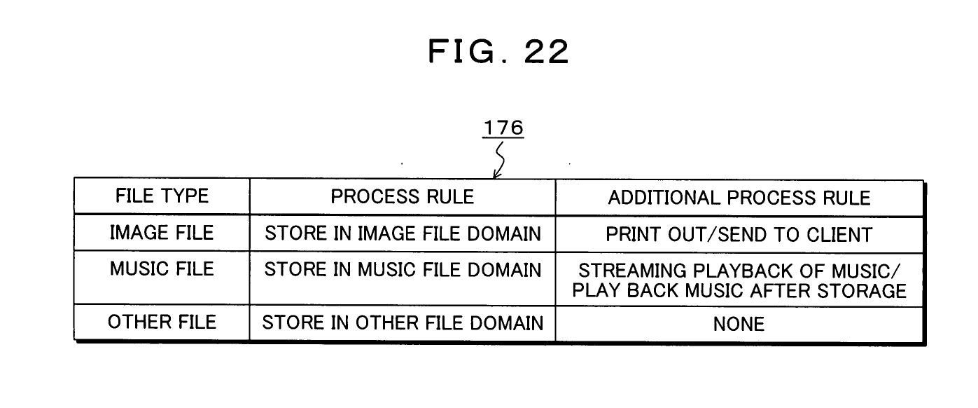

FIG. 22 shows another embodiment of a list of processings corresponding to file types 176 set in the processing rule definition unit 52 disposed on the server 12 of FIGS. 5A and 5B, and the list of processings corresponding to file types 176 is characterized in that the storage playback and the streaming playback can be set for the music playback. FIG. 22 is an explanatory diagram of the list of processings corresponding to file types 176. For the image files and other files, the list of processings corresponding to file types 176 is the same as the list of processings corresponding to file types 106 of FIG. 7, and for the music file, the processing rule in the case that the instruction of the additional processing is not present is the same as “store in music file domain”, but as the additional processing, either of “streaming playback of music/play back music after storage” may be selected.

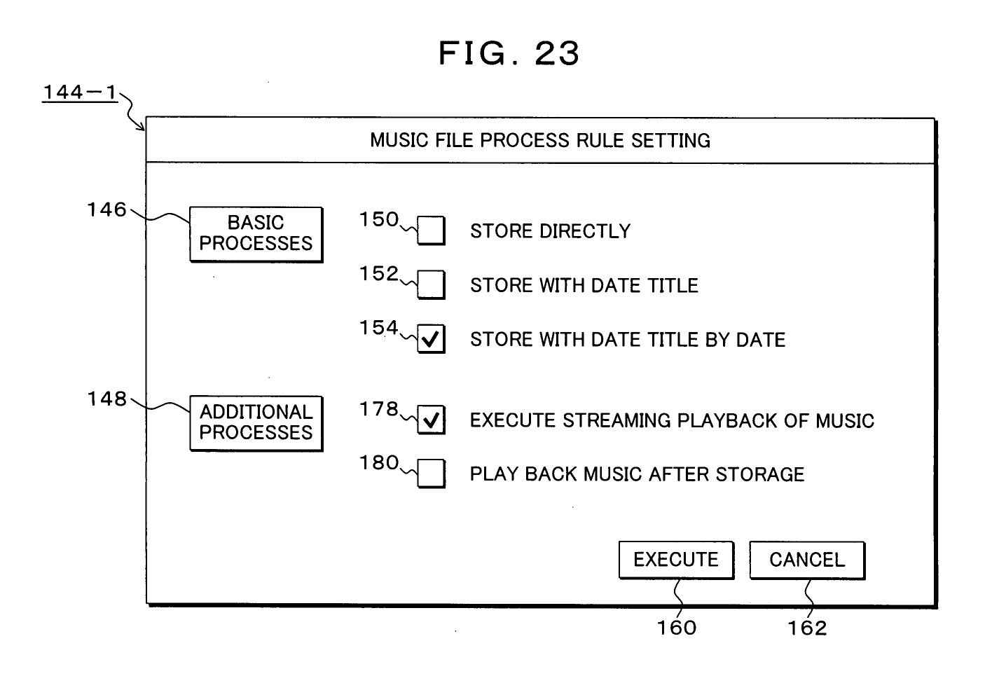

FIG. 23 is an explanatory diagram of a music file processing rule setting screen 144-1 used for setting the music file processing rules in the list of processings corresponding to file types 176 of FIG. 22. In this music file processing rule setting screen 144-1, as the additional processing 148, “execute streaming playback of music” may be set by a check box 178, and “play back music after storage” may be set by a check box 180. For these additional processings 148, for example the check box 178 is set as a useful application. At this point, the streaming playback of music is started when the copied amount in a buffer reaches to the predefined amount during the music file is copied from the medium inserted into the card slot 26, and the copying and the playback can be executed concurrently, therefore almost real-time music playback is possible. Contrary to this, in the music playback after storage, since the music file is played back after the copying to the buffer is completed, the playback delay will occur for an amount of time to copy the music file. Thus, the user can set whether the streaming playback or the music playback after storage is executed, as appropriate, as the additional processing rule in the processing rule definition unit 52 of the server 12, using the music file processing rule setting screen 144-1. It is noted that, in above embodiment, the server is taken as an example of the electronic apparatus to which the invention is applied, but the invention is not limited to this, includes the case that the invention is applied to a personal computer which is not usually called as a server and is not limited to a server. Also, in above embodiments, taken as an example are the file storage and the additional processing according to the additional processing instruction when the data is input by inserting the medium into the card slot 26 of the server, but the input of the file may be executed using a plurality of I/O processing units simultaneously. For example, at the same time of the file input by the medium insertion to the card slot, the file input to the WAN connector 40 or the USB connector 42 may be executed concurrently to process the file storage. For the additional processings in the case that a plurality of files are input simultaneously in this way, dedicated additional processing instruction switches for each input may be provided. Also, for the instruction of the additional processing from the side of the personal computers, the file management screen on which the instruction of the additional processing can be set individually for each input may be prepared. Further, in above embodiments, taken as an example of the files to be the input objects are the image files of the digital camera 44 and the music files captured from CD and the memory card, but the invention is not limited thereto but may be applied intactly to any suitable image files and files. The above embodiments do not by any means impose restrictions on the method to divide the storage domain for storing input files and on the method to generate the file name which is added to the file, and any suitable processings may be executed as appropriate.

1. An electronic apparatus comprising:
a file I/O unit which inputs and outputs a file;
a file storage unit which stores a file;
a processing unit which stores the file input from the file I/O unit into the file storage unit in conformity with a predefined processing rule; and
an additional processing instruction unit which forces the processing unit to execute a predefined additional processing corresponding to a file type when an instruction of the additional processing is determined.

2. The electronic apparatus according to claim 1, wherein
the file I/O unit inputs a file from a medium connected directly or via an adaptor to a medium connection port of the apparatus.

3. The electronic apparatus according to claim 1, wherein
the file I/O unit inputs an image file or a music file.

4. The electronic apparatus according to claim 1, wherein
the processing unit stores the input file in a domain of the file storage unit corresponding to each file type.

5. The electronic apparatus according to claim 1, wherein
the processing unit generates a file name for each of the input files and stores the input files with file names imparted to domains of the file storage unit corresponding to the file types.

6. The electronic apparatus according to claim 1, wherein
the processing unit divides inside of the domains of the file storage unit corresponding to the file types into dated domains based on date information of the input files to store the input files.

7. The electronic apparatus according to claim 1, wherein
the processing unit generates a file name for each of the input files, divides inside of the domains of the file storage unit corresponding to file types into dated domains based on date information of the input files, sorts and stores the input files by date with the file names imparted thereto.

8. The electronic apparatus according to claim 7, wherein
the processing unit generates file names with serial numbers added to the date information of the input files, divides inside of the domains of the file storage unit corresponding to file types into dated domains, sorts and stores the input files by date with the file names imparted thereto.

9. The electronic apparatus according to claim 7, wherein
the electronic apparatus is a server, and wherein
the additional processing instruction unit recognizes and handles an instruction of additional processing from manipulation of a switch disposed on the apparatus.

10. The electronic apparatus according to claim 7, wherein the electronic apparatus is a server, and wherein
the additional processing instruction unit recognizes and handles an instruction of additional processing from the client.

11. The electronic apparatus according to claim 7, wherein the electronic apparatus is a server, and wherein
when the input file is an image file, the additional processing instruction unit forces the processing unit to print out by the printer.

12. The electronic apparatus according to claim 7, wherein
the electronic apparatus is a server, and wherein
when the input file is a music file, the additional processing instruction unit forces the processing unit to play back music by the client.

13. The electronic apparatus according to claim 7, wherein the electronic apparatus is a server, and wherein
when the input file is a music file, the additional processing instruction unit forces the processing unit to generate a play list and send it with the music file to a music electronic apparatus.

14. A processing method comprising:
a file input step of inputting a file;
a file storage step of storing the input file into the file storage unit in conformity with a predefined processing rule corresponding to a file type; and
an additional processing step of, when the instruction of the additional processing is determined, effecting on the input file predefined additional processing corresponding to the file type.

15. The processing method according to claim 14, wherein
the file storage step includes generating a file name for each of the input files, dividing inside of domains of the file storage unit corresponding to file types into dated domains based on date information of the input files, and sorting and storing the input files by date with the file names imparted thereto.

16. The processing method according to claim 14, wherein
the electronic apparatus is a server, and wherein
the additional processing step includes, when the input file is an image file, forcing a printer connected to the server to print out, and wherein
the additional processing step includes, when the input file is a music file, forcing a client connected to the server to play back music.

17. A program operable to cause a computer to ececute:
a file input step of inputting a file;
a file storage step of storing the input file into the file storage unit in conformity with a predefined processing rule corresponding to a file type; and
an additional processing step of, when the instruction of the additional processing is determined, effecting on the input file predefined additional processing corresponding to the file type.

18. The program according to claim 17, wherein
the file storage step includes generating a file name for each of the input files, dividing inside of domains of the file storage unit corresponding to file types into dated domains based on date information of the input files, and sorting and storing the input files by date with the file names imparted thereto.

19. The program according to claim 17, wherein
the additional processing step includes, when the input file is an image file, forcing a printer connected to the server to print out, and wherein
the additional processing step includes, when the input file is a music file, forcing a client connected to the server to play back music.
